(19) United States
(12) Patent Application Publication
(10) Pub. No.: US 2008/0196658 A1
(43) Pub. Date: Aug. 21, 2008

(54) SUBSTRATE PROCESSING APPARATUS INCLUDING A SUBSTRATE REVERSING REGION

(75) Inventors: Yoshiteru Fukutomi, Kyoto (JP); Masami Ohtani, Kyoto (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sokudo Co., Ltd., Shimogyo-ku (JP)

(21) Appl. No.: 12/031,674

(22) Filed: Feb. 14, 2008

(30) Foreign Application Priority Data
Feb. 15, 2007 (JP) 2007-034199

(51) Int. Cl. B05C 11/00; B08B 13/00

(52) U.S. Cl. 118/58; 134/63

(57) ABSTRACT

A substrate processing apparatus that is arranged adjacent to an exposure device includes a processing section including a first processing unit and a second processing unit. The first processing unit includes a development region, a first cleaning region, and a first transport region. The development region and the first cleaning region are arranged opposite to each other with the first transport region interposed therebetween. The second processing unit includes a reversing region, a second cleaning region, and a second transport region. The reversing region and the second cleaning region are arranged opposite to each other with the second transport region interposed therebetween. The second processing unit is arranged between the first processing unit and the exposure device. The substrate processing apparatus also includes a transfer section coupled to the processing section and an interface configured to receive and transfer the substrate between the processing section and the exposure device.

### CROSS-REFERENCES TO RELATED APPLICATIONS

This application claims priority to Japanese Patent Application 2007-034199, filed Feb. 15, 2007. The disclosure of JP 2007-034199 is hereby incorporated by reference in its entirety for all purposes.

### BACKGROUND OF THE INVENTION

The present invention relates to a substrate processing apparatus that subjects substrates to processing.

Substrate processing apparatuses are used to subject various types of substrates such as semiconductor substrates, substrates for liquid crystal displays, plasma displays, optical disks, magnetic disks, magneto-optical disks, and photomasks, and other substrates to various types of processing.

Such a substrate processing apparatus generally subjects a single substrate to a plurality of different types of processing successively (see, for example, JP 2003-324139). The substrate processing apparatus as described in JP 2003-324139 A includes an indexer block, an anti-reflection film processing block, a resist film processing block, a development processing block, and an interface block. An exposure device is arranged adjacent to the interface block as an external device separate from the substrate processing apparatus.

In the above-mentioned substrate processing apparatus, a substrate carried out of the indexer block is transported to the exposure device through the interface block after being subjected to anti-reflection film formation and resist film coating processing in the anti-reflection film processing block and the resist film processing block. After a resist film on the substrate is subjected to exposure processing in the exposure device, the substrate is transported to the development processing block through the interface block. After the resist film on the substrate is subjected to development processing to form a resist pattern thereon in the development processing block, the substrate is transported to the indexer block.

With recent increases in density and integration of devices, making finer resist patterns has become an important problem. Conventional exposure devices have generally performed exposure processing by reduction-projecting reticle patterns on substrates through projection lenses. With such conventional exposure devices, however, the line widths of exposure patterns are determined by the wavelengths of light sources of the exposure devices. Therefore, making finer resist patterns have had limitations.

Therefore, a liquid immersion method is suggested as a projection exposure method allowing for finer exposure patterns (see, for example, WO99/49504 pamphlet). In a projection exposure device according to the WO99/49504 pamphlet, an area between a projection optical system and a substrate is filled with a liquid, resulting in a shorter wavelength of exposure light on a top surface of the substrate. This allows for finer exposure patterns.

When a substrate is subjected to exposure processing by means of the liquid immersion method disclosed in the above-mentioned WO99/49504 pamphlet, however, a contaminant that has adhered to a back surface of the substrate is mixed into a liquid within the exposure device if the back surface of the substrate is contaminated. Thus, a lens of the exposure device may be contaminated, resulting in a defective dimension and a defective shape of an exposure pattern. Thus, there is a need in the art for improved methods and systems for processing substrates.

### SUMMARY OF THE INVENTION

An object of the present invention is to provide a substrate processing apparatus that can prevent pattern defects caused by contamination on a back surface of a substrate.

According to an aspect of the present invention, a substrate processing apparatus that is arranged adjacent to an exposure device includes a processing section that subjects a substrate to predetermined processing, a carry-in/carry-out section for carrying the substrate into and out of the processing section (also referred to as a transfer section), and an interface for receiving and transferring the substrate between the processing section and the exposure device. The processing section includes a first processing unit and a second processing unit that are arranged adjacent to each other.

The first processing unit has a development region, a first cleaning region, and a first transport region. The development region and the first cleaning region are arranged opposite to each other with the first transport region interposed therebetween. The development region is provided with a development unit that subjects the substrate to development processing after exposure processing by the exposure device. The first cleaning region is provided with a top surface cleaning unit that cleans a top surface of the substrate. The first transport region is provided with a first transport unit that transports the substrate.

The second processing unit is arranged between the first processing unit and the exposure device and includes a reversing region, a second cleaning region, and a second transport region. The reversing region and the second cleaning region are arranged opposite to each other with the second transport region interposed therebetween. The reversing region is provided with a reversing unit that reverses one surface and the other surface of the substrate. The second cleaning region is provided with a back surface cleaning unit that cleans a back surface of the substrate. The second transport region is provided with a second transport unit that transports the substrate.

In the substrate processing apparatus, the carry-in/carry-out section carries the substrate into the processing section. In the first processing unit in the processing section, the top surface cleaning unit cleans the top surface of the substrate, and the first transport unit transports the substrate before or after the cleaning. Furthermore, in the second processing unit, the reversing unit reverses the substrate, the back surface cleaning unit cleans the back surface of the reversed substrate, and the second transport unit transports the substrate before or after the reversing or after the cleaning.

The interface carries the substrate that has been transferred from the processing section into the exposure device. Thus, the exposure device subjects the substrate to the exposure processing. The substrate after the exposure processing is carried out of the exposure device, and is transferred to the processing section by the interface. The second transport unit provided in the second processing unit in the processing section transports the substrate to the first processing unit.

In the first processing unit, the development unit subjects the substrate to the development processing, and the first transport unit transports the substrate before or after the development processing. The carry-in/carry-out section carries the substrate out of the processing section.

According to another embodiments of the substrate processing apparatus, the back surface cleaning unit can clean the back surface of the substrate before the exposure processing. This causes the back surface of the substrate before the exposure processing by the exposure device to be kept clean. Furthermore, the top surface cleaning unit can also clean the top surface of the substrate before the exposure processing by the exposure device. This causes the top surface of the substrate before the exposure processing to be kept clean. As a result, contamination in the exposure device due to contamination on the top surface and the back surface of the substrate is prevented, which sufficiently prevents a defective dimension and a defective shape of an exposure pattern.

In the processing section, the first processing unit and the second processing unit are adjacent to each other and are arranged in this order toward the exposure device. This allows the cleaning of the top surface of the substrate by the first processing unit and the cleaning of the back surface of the substrate by the second processing unit to be continuously performed when the substrate is transported to the exposure device. Thus, the top surface and the back surface of the substrate are efficiently cleaned, which allows the cleanliness of the substrate to be improved.

In the second processing unit, the reversing unit and the back surface cleaning unit are provided opposite to each other with the second transport unit interposed therebetween. Thus, the second transport unit can easily and quickly transport the substrate between the reversing unit and the back surface cleaning unit. This causes throughput in substrate processing to be improved.

In the first processing unit, the development unit and the top surface cleaning unit are provided. This allows the development processing of the substrate and the cleaning processing on the top surface of the substrate to be continuously performed in parallel. As a result, throughput in substrate processing is improved.

In an alternative embodiment, the top surface cleaning unit and the back surface cleaning unit may clean the substrate before the exposure processing by the exposure device. This causes the top surface and the back surface of the substrate before the exposure processing to be cleaned. As a result, contamination in the exposure device due to contamination on the top surface and the back surface of the substrate is reliably prevented, which sufficiently prevents a defective dimension and a defective shape of an exposure pattern.

In yet another alternative embodiment, the top surface cleaning unit may clean the top surface and an edge of the substrate. In this case, the top surface, the edge, and the back surface of the substrate before the exposure processing can be cleaned. This causes the whole surface of the substrate before the exposure processing to be kept clean. As a result, contamination in the exposure device due to contamination of the whole substrate is reliably prevented, which sufficiently prevents a defective dimension and a defective shape of an exposure pattern.

The processing section may further include a third processing unit arranged between the first processing unit and the carry-in/carry-out section. The third processing unit includes a photosensitive film formation region, a first thermal processing region, and a third transport region. The photosensitive film formation region may be provided with a photosensitive film formation unit that forms a photosensitive film composed of a photosensitive material on the substrate before the exposure processing by the exposure device. The first thermal processing region may be provided with a first thermal processing unit that subjects the substrate to thermal processing. The third transport region may be provided with a third transport unit that transports the substrate.

In this case, in the third processing unit in the processing section, the photosensitive film formation unit forms the photosensitive film on the substrate, the first thermal processing unit subjects the substrate to the thermal processing, and the third transport unit transports the substrate before or after the formation of the photosensitive film or after the thermal processing. Thus, the substrate on which the photosensitive film has been formed can be subjected to quick thermal processing. This causes throughput in substrate processing to be improved.

Furthermore, in the first and second processing units, the top surface and the back surface of the substrate on which the photosensitive film has been formed can be cleaned before the exposure processing.

The first thermal processing unit may include a thermal processing unit for development that subjects the substrate after the development processing by the development unit to thermal processing, and a thermal processing unit for photosensitive film that subjects the substrate after the formation of the photosensitive film by the photosensitive film formation unit to thermal processing.

In this case, in the third processing unit, the thermal processing unit for photosensitive film can subject the substrate on which the photosensitive film has been formed to quick thermal processing. Furthermore, the thermal processing unit for development in the third processing unit can subject the substrate after the development processing by the development unit in the first processing unit to quick thermal processing. This causes throughput in substrate processing to be improved.

In a particular embodiment, the processing section may further include a fourth processing unit arranged between the third processing unit and the carry-in/carry-out section. The fourth processing unit includes an anti-reflection film formation region, a second thermal processing region, and a fourth transport region. The anti-reflection film formation region may be provided with an anti-reflection film formation unit that forms an anti-reflection film on the substrate before the photosensitive film formation unit forms the photosensitive film. The second thermal processing region may be provided with a second thermal processing unit that subjects the substrate to thermal processing. The fourth transport region may be provided with a fourth transport unit that transports the substrate.

In this case, in the fourth processing unit in the processing section, the anti-reflection film is formed on the substrate before the formation of the photosensitive film, the second thermal processing unit subjects the substrate to the thermal processing, and the fourth transport unit transports the substrate before or after the formation of the anti-reflection film or after the thermal processing. This allows standing waves and halation generated during the exposure processing to be reduced. Furthermore, the substrate on which the anti-reflection film has been formed can be subjected to quick thermal processing. This allows throughput in substrate processing to be improved.

In an embodiment, the interface includes a cleaning/drying unit that cleans and dries the substrate after the exposure processing by the exposure device, and an interface unit that transports the substrate. In this case, the cleaning/drying unit cleans and dries the substrate after the exposure processing by the exposure device, and the interface unit transports the substrate before the cleaning or after the drying. A liquid that has adhered to the substrate after the exposure processing can be prevented from dropping in the processing section, which can prevent operational troubles such as abnormalities in an electric system of the substrate processing apparatus.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a plan view of a substrate processing apparatus according to an embodiment of the present invention;

FIG. 2 is a side view on one side of the substrate processing apparatus shown in FIG. 1;

FIG. 3 is a side view on the other side of the substrate processing apparatus shown in FIG. 1;

FIG. 4 is a diagram for explaining the configuration of a top surface and edge cleaning/drying unit;

FIG. 5 is a schematic view for explaining an edge of a substrate;

FIG. 6 is a diagram for explaining the configuration of an edge cleaning device in the top surface and edge cleaning/drying unit shown in FIG. 4;

FIG. 7 is a diagram for explaining another example of the configuration of the top surface and edge cleaning/drying unit;

FIG. 8 is a diagram for explaining the configuration of a back surface cleaning unit;

FIG. 9 is a perspective view showing the appearance of a substrate reversing device provided in a reversing unit;

FIG. 10 is a perspective view showing the appearance of a part of the substrate reversing device;

FIG. 11 is a schematic view showing the operations of the substrate reversing device shown in FIG. 9; and

FIG. 12 is a schematic view showing the operations of the substrate reversing device shown in FIG. 9.

### DETAILED DESCRIPTION OF SPECIFIC EMBODIMENTS

A substrate processing apparatus according to an embodiment of the present invention will be described with reference to the drawings. In the following description, a substrate refers to a semiconductor substrate, a substrate for a liquid crystal display, a substrate for a plasma display, a glass substrate for a photomask, a substrate for an optical disk, a substrate for a magnetic disk, a substrate for a magneto-optical disk, a substrate for a photomask, or the like.

In the following description, a surface, on which various patterns such as a circuit pattern are formed, of the substrate is referred to as a top surface, and a surface on the opposite side thereto is referred to as a back surface. Furthermore, a surface, directed downward, of the substrate is referred to as a lower surface, and a surface, directed upward, of the substrate is referred to as an upper surface.

Furthermore, the following drawings are accompanied by arrows that respectively indicate X, Y, and Z directions perpendicular to one another for clarity of a positional relationship. The X and Y directions are perpendicular to each other within a horizontal plane, and the Z direction corresponds to a vertical direction. In each of the directions, the direction of the arrow is defined as a + (positive) direction, and the opposite direction is defined as a − (negative) direction. A rotation direction centered around the Z direction is defined as a θ direction.

Configuration of the Substrate Processing Apparatus

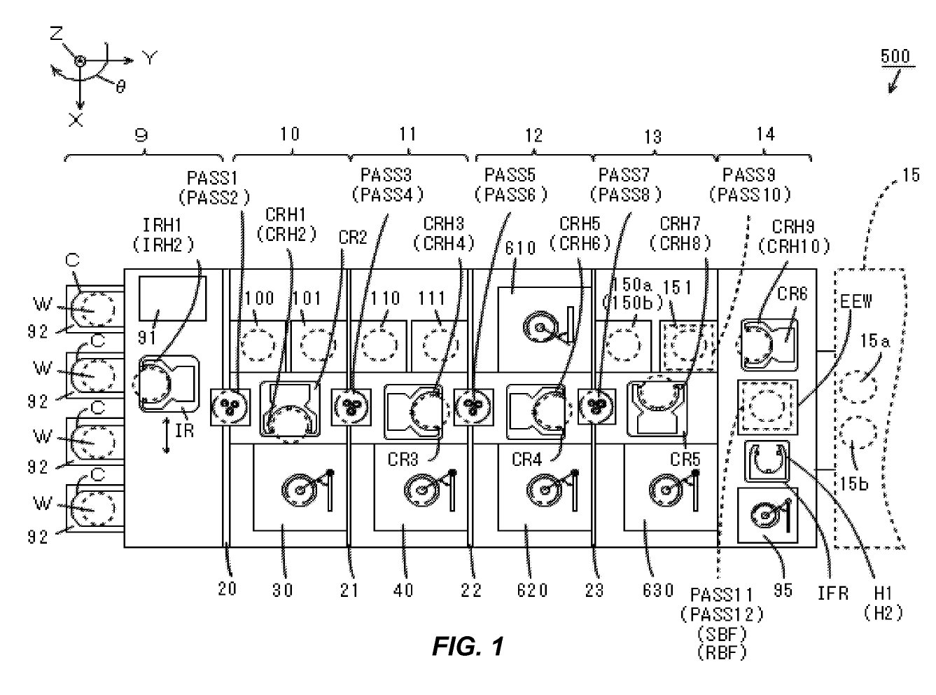

FIG. 1 is a plan view of a substrate processing apparatus 500 according to an embodiment of the present invention. As shown in FIG. 1, the substrate processing apparatus 500 includes an indexer block 9, an anti-reflection film processing block 10, a resist film processing block 11, a development/cleaning/drying processing block 12, a cleaning/drying processing block 13, and an interface block 14. In the substrate processing apparatus 500, the blocks 9 to 14 are provided side by side in the foregoing order.

An exposure device 15 is arranged adjacent to the interface block 14 in the substrate processing apparatus 500. The exposure device 15 subjects a substrate W to exposure processing by means of a liquid immersion method.

The indexer block 9 includes a main controller (controller) 91 for controlling the operation of each of the blocks, a plurality of carrier platforms 92, and an indexer robot IR. The indexer robot IR has hands IRH1 and IRH2 provided one above the other for receiving and transferring the substrates W.

The anti-reflection film processing block 10 includes thermal processing groups 100 and 101 for anti-reflection film, a coating processing group 30 for anti-reflection film, and a second central robot CR2. The coating processing group 30 is provided opposite to the thermal processing groups 100 and 101 with the second central robot CR2 interposed therebetween. The second central robot CR2 has hands CRH1 and CRH2 provided one above the other for receiving and transferring the substrates W.

A partition wall 20 is provided between the indexer block 9 and the anti-reflection film processing block 10 for shielding an atmosphere. The partition wall 20 has substrate platforms PASS1 and PASS2 provided in close proximity one above the other for receiving and transferring the substrates W between the indexer block 9 and the anti-reflection film processing block 10. The upper substrate platform PASS1 is used in transporting the substrates W from the indexer block 9 to the anti-reflection film processing block 10, and the lower substrate platform PASS2 is used in transporting the substrates W from the anti-reflection film processing block 10 to the indexer block 9.

Each of the substrate platforms PASS1 and PASS2 is provided with an optical sensor (not shown) for detecting the presence or absence of the substrate W. This allows determination to be made whether or not the substrate W is placed on the substrate platform PASS1 or PASS2. In addition, each of the substrate platforms PASS1 and PASS2 has a plurality of support pins secured thereto. Note that each of substrate platforms PASS3 to PASS12 described later is similarly provided with an optical sensor and support pins.

The resist film processing block 11 includes a thermal processing group 110 for resist film, a thermal processing group 111 for development, a coating processing group 40 for resist film, and a third central robot CR3. The coating processing group 40 is provided opposite to the thermal processing group 110 and the thermal processing group 111 with the third central robot CR3 interposed therebetween. The third central robot CR3 has hands CRH3 and CRH4 provided one above the other for receiving and transferring the substrates W.

A partition wall 21 is provided between the anti-reflection film processing block 10 and the resist film processing block 11 for shielding an atmosphere. The partition wall 21 has substrate platforms PASS3 and PASS4 provided in close proximity one above the other for receiving and transferring the substrates W between the anti-reflection film processing block 10 and the resist film processing block 11. The upper substrate platform PASS3 is used in transporting the substrates W from the anti-reflection film processing block 10 to the resist film processing block 11, and the lower substrate platform PASS4 is used in transporting the substrates W from the resist film processing block 11 to the anti-reflection film processing block 10.

The development/cleaning/drying processing block 12 includes a first cleaning/drying processing group 610, a development processing group 620, and a fourth central robot CR4. The first cleaning/drying processing group 610 and the development processing group 620 are provided opposite to each other with the fourth central robot CR4 interposed therebetween. The fourth central robot CR4 has hands CRH5 and CRH6 provided one above the other for receiving and transferring the substrates W.

A partition wall 22 is provided between the resist film processing block 11 and the development/cleaning/drying processing block 12 for shielding an atmosphere. The partition wall 22 has substrate platforms PASS5 and PASS6 provided in close proximity one above the other for receiving and transferring the substrates W between the resist film processing block 11 and the development/cleaning/drying processing block 12. The upper substrate platform PASS5 is used in transporting the substrates W from the resist film processing block 11 to the development/cleaning/drying processing block 12, and the lower substrate platform PASS6 is used in transporting the substrates W from the development/cleaning/drying processing block 12 to the resist film processing block 11.□

The cleaning/drying processing block 13 includes a substrate reversing group 150a, thermal processing groups 150b and 151 for post-exposure bake, a second cleaning/drying processing group 630, and a fifth central robot CR5. The thermal processing group 151 is adjacent to the interface block 14, and includes substrate platforms PASS9 and PASS10, as described later. The second cleaning/drying processing group 630 is provided opposite to the substrate reversing group 150a and the thermal processing groups 150b and 151 with the fifth central robot CR5 interposed therebetween. The fifth central robot CR5 has hands CRH7 and CRH8 provided one above the other for receiving and transferring the substrates W.

A partition wall 23 is provided between the development/cleaning/drying processing block 12 and the cleaning/drying processing block 13 for shielding an atmosphere. The partition wall 23 has substrate platforms PASS7 and PASS8 provided in close proximity one above the other for receiving and transferring the substrates W between the development/cleaning/drying processing block 12 and the cleaning/drying processing block 13. The upper substrate platform PASS7 is used in transferring the substrates W from the development/cleaning/drying processing block 12 to the cleaning/drying processing block 13, and the lower substrate platform PASS8 is used in transferring the substrates W from the cleaning/drying processing block 13 to the development/cleaning/drying processing block 12.

The interface block 14 has a sixth center robot CR6, an edge exposure unit EEW, an interface transporting mechanism IFR, and a post-exposure cleaning/drying processing group 95 arranged along the +X direction in this order. Substrate platforms PASS11 and PASS12, a sending buffer unit SBF, and a return buffer unit RBF, described later, are provided below the edge exposure unit EEW. The sixth central robot CR6 has hands CRH9 and CRH 10 provided one above the other for receiving and transferring the substrates W, and the interface transporting mechanism IFR has hands H1 and H2 provided one above the other for receiving and transferring the substrates W.

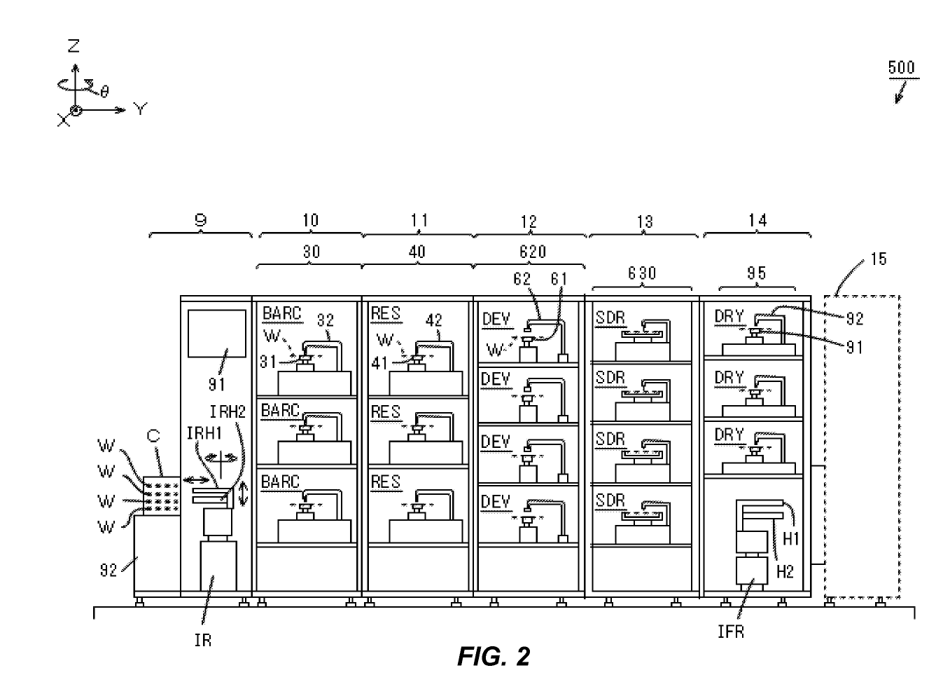

FIG. 2 is a side view on one side of the substrate processing apparatus 500 shown in FIG. 1. The coating processing group 30 (see FIG. 1) in the anti-reflection film processing block 10 has a vertical stack of three coating units BARC. Each of the coating units BARC includes a spin chuck 31 for rotating the substrate W with the substrate W held in a horizontal attitude by suction, and a supply nozzle 32 for supplying a coating liquid for an anti-reflection film to the substrate W held on the spin chuck 31.

The coating processing group 40 (see FIG. 1) in the resist film processing block 11 has a vertical stack of three coating units RES. Each of the coating units RES includes a spin chuck 41 for rotating the substrate W with the substrate W held in a horizontal attitude by suction, and a supply nozzle 42 for supplying a coating liquid for a resist film to the substrate W held on the spin chuck 41.

The development processing group 620 (see FIG. 1) in the development/cleaning/drying processing block 12 includes a vertical stack of four development processing units DEV. Each of the development processing units DEV includes a spin chuck 61 for rotating the substrate W with the substrate W held in a horizontal attitude by suction, and a supply nozzle 62 for supplying a development liquid to the substrate W held on the spin chuck 61.

The second cleaning/drying processing group 630 (see FIG. 1) in the cleaning/drying processing block 13 has a vertical stack of four back surface cleaning units SDR. Here, the back surface cleaning unit SDR is used for cleaning the back surface of the substrate W. The substrate W is carried into the back surface cleaning unit SDR with the back surface of the substrate W directed upward. The details of the back surface cleaning unit SDR will be described later.

The cleaning/drying processing group 95 in the interface block 14 has a vertical stack of three post-exposure cleaning/drying units DRY. Each of the post-exposure cleaning/drying units DRY includes a spin chuck 91 for rotating the substrate W with the substrate W held in a horizontal attitude by suction, and a nozzle 92 for supplying a processing liquid for cleaning (a cleaning liquid and a rinse liquid) to the substrate W held on the spin chuck 91.

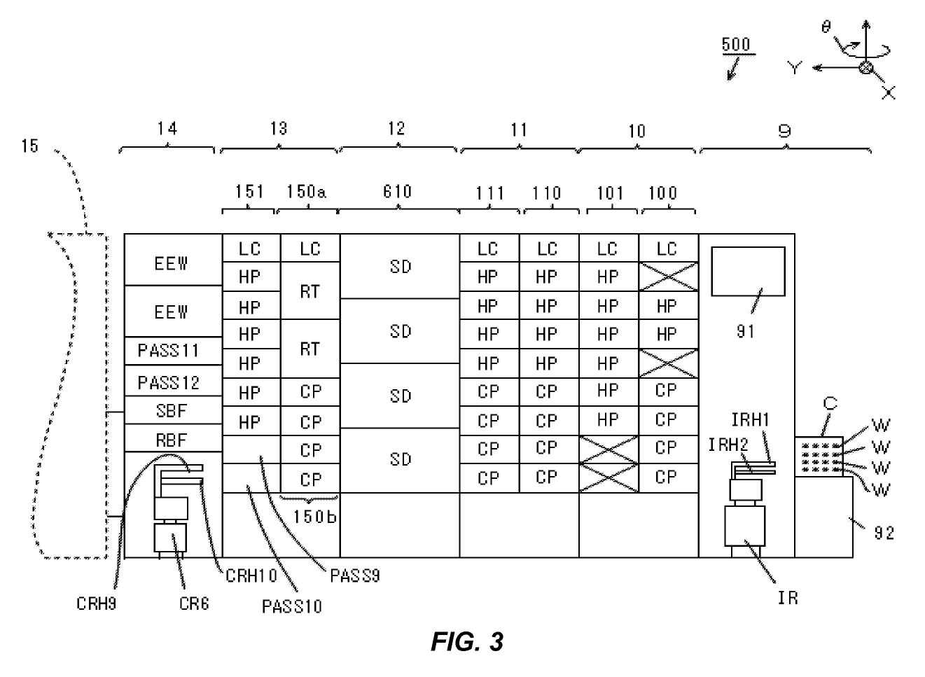

FIG. 3 is a side view on the other side of the substrate processing apparatus 500 shown in FIG. 1. In the anti-reflection film processing block 10, the thermal processing group 100 has a vertical stack of two heating units (hot plates) HP and four cooling units (cooling plates) CP, and the thermal processing group 101 has a vertical stack of six heating units HP. Furthermore, each of the thermal processing groups 100 and 101 has a local controller LC for controlling the respective temperatures of the heating unit HP and the cooling unit CP arranged in its uppermost part.

In the resist film processing block 11, the thermal processing group 110 has a vertical stack of four heating units HP and four cooling units CP, and the thermal processing group 111 has a vertical stack of four heating units HP and four cooling units CP. Furthermore, each of the thermal processing groups 110 and 111 has a local controller LC for controlling the respective temperatures of the heating unit HP and the cooling unit CP arranged in its uppermost part.

The first cleaning/drying processing group 610 in the development/cleaning/drying processing block 12 has a vertical stack of four top surface and edge cleaning/drying units SD. The details of the top surface and edge cleaning/drying unit SD will be described later.

In the cleaning/drying processing block 13, the thermal processing group 151 is provided adjacent to the interface block 14. The thermal processing group 151 has a vertical stack of six heating units HP and substrate platforms PASS9 and PASS10. The thermal processing group 151 has a local controller LC arranged in its uppermost part.

The substrate reversing group 150a and the thermal processing group 150b are vertically stacked adjacent to the thermal processing group 151. The substrate reversing group 150a in the cleaning/drying processing block 13 has a vertical stack of two reversing units RT. Furthermore, the thermal processing group 150b has a vertical stack of four cooling units CP. Note that the substrate reversing group 150a has a local controller LC for controlling the operation of the reversing unit RT and the temperature of the cooling unit CP in the thermal processing group 150b arranged in its uppermost part.

Here, the reversing unit RT is used for reversing one surface (top surface) and the other surface (back surface) of the substrate W. When the top surface of the substrate W is directed upward, for example, the reversing unit RT reverses the substrate W such that the back surface of the substrate W is directed upward. The details of the reversing unit RT will be described later.

The interface block 14 has a vertical stack of two edge exposure units EEW, substrate platforms PASS11 and PASS12, a sending buffer unit SBF, and a return buffer unit RBF arranged in its substantially central part (see FIG. 1). Each of the edge exposure units EEW includes a spin chuck (not shown) for rotating the substrate W with the substrate W held in a horizontal attitude by suction, and a light irradiator (not shown) for exposing a peripheral portion of the substrate W held on the spin chuck. Note that the respective numbers of coating units BARC and RES, post-exposure cleaning/drying units DRY, edge exposure units EEW, heating units HP, and cooling units CP may be changed, as needed, depending on the processing speed of each of the blocks 10 to 14.

Operations of the Substrate Processing Apparatus

The operations of the substrate processing apparatus 500 according to the present embodiment will be then described with reference to FIGS. 1 to 3. Carriers C that each store a plurality of substrates W in multiple stages are respectively placed on the carrier platforms 92 in the indexer block 9. Here, in the present embodiment, the plurality of substrates W that are stored in each of the carriers C are held with their top surfaces directed upward.

The indexer robot IR takes out the unprocessed substrate W that is stored in the carrier C using the upper hand IRH1. Thereafter, the indexer robot IR rotates in the ±0 direction while moving in the ±X direction, to place the unprocessed substrate W on the substrate platform PASS1. Although FOUPs (Front Opening Unified Pods) are adopted as the carriers C in the present embodiment, the present invention is not limited to the same. For example, SMIF (Standard Mechanical Inter Face) pods, or OCs (Open Cassettes) that expose the stored substrates W to outside air may be used.

Furthermore, although linear-type transport robots that move their hands forward or backward by linearly sliding them to the substrates W are respectively used as the indexer robot IR, the second to sixth central robots CR2 to CR6, and the interface transporting mechanism IFR, the present invention is not limited to the same. For example, multi-joint type transport robots that linearly move their hands forward and backward by moving their joints may be used.

The substrate W placed on the substrate platform PASS1 is received by the second central robot CR2 in the anti-reflection film processing block 10. The second central robot CR2 carries the substrate W into the coating processing group 30. In the coating processing group 30, the coating unit BARC forms a coating of an anti-reflection film on the substrate W in order to reduce standing waves and halation generated during the exposure processing. Thereafter, the second central robot CR2 then takes out the substrate W after the coating processing from the coating processing group 30, and carries the substrate W into the thermal processing group 100 or 101. Then, the second central robot CR2 takes out the thermally processed substrate W from the thermal processing group 100 or 101, and places the substrate W on the substrate platform PASS3.

The substrate W placed on the substrate platform PASS3 is received by the third central robot CR3 in the resist film processing block 11. The third central robot CR3 carries the substrate W into the coating processing group 40. In the coating processing group 40, the coating unit RES forms a coating of a resist film on the anti-reflection film. Thereafter, the third central robot CR3 takes out the substrate W after the coating processing from the coating processing group 40, and carries the substrate W into the thermal processing group 110 or 111. Then, the third central robot CR3 takes out the thermally processed substrate W from the thermal processing group 110 or 111, and places the substrate W on the substrate platform PASS5.

The substrate W placed on the substrate platform PASS5 is received by the fourth central robot CR4 in the development/cleaning/drying processing block 12. The fourth central robot CR4 carries the substrate W into the top surface and edge cleaning/drying unit SD in the first cleaning/drying processing group 610. The top surface and edge cleaning/drying processing unit SD subjects the substrate W that has carried thereinto to top surface and edge cleaning processing, described later. This causes the top surface and an edge of the substrate W before the exposure processing by the exposure device 15 to be kept clean.

Thereafter, the fourth central robot CR4 takes out the substrate W after the top surface and edge cleaning processing from the top surface and edge cleaning/drying unit SD, and places the substrate W on the substrate platform PASS7.

The substrate W placed on the substrate platform PASS7 is received by the fifth central robot CR5 in the cleaning/drying processing block 13. The fifth central robot CR5 carries the substrate W into the reversing unit RT in the substrate reversing group 150a. The reversing unit RT reverses one surface and the other surface of the substrate W, as described above. That is, the reversing unit RT reverses the substrate W whose top surface is directed upward such that the back surface thereof is directed upward. Subsequently, the fifth central robot CR5 takes out the substrate W whose back surface is directed upward from the reversing unit RT, and carries the substrate W into the back surface cleaning unit SDR in the second cleaning/drying processing group 630. The back surface cleaning unit SDR cleans the back surface of the substrate W. This causes the back surface of the substrate W before the exposure processing by the exposure device 15 to be kept clean. Then, the fifth central robot CR5 takes out the substrate W whose back surface has been cleaned from the back surface cleaning unit SDR, and carries the substrate W into the reversing unit RT in the substrate reversing group 150a.

Therefore, the reversing unit RT reverses the substrate W whose back surface is directed upward such that the top surface thereof is directed upward. The fifth central robot CR5 takes out the substrate W whose top surface is directed upward from the reversing unit RT, and places the substrate W on the substrate platform PASS9.

The substrate W placed on the substrate platform PASS9 is received by the sixth central robot CR6 in the interface block 14. The sixth central robot CR6 carries the substrate W into the edge exposure unit EEW. The edge exposure unit EEW subjects the peripheral portion of the substrate W to edge exposure processing. Then, the sixth central robot CR6 takes out the substrate W that has been subjected to the edge exposure processing from the edge exposure unit EEW, and places the substrate W on the substrate platform PASS11.

The substrate W placed on the substrate platform PASS11 is carried into a substrate carry-in section 15a (see FIG. 1) in the exposure device 15 by the interface transporting mechanism IFR. When the exposure device 15 cannot receive the substrate W, the substrate W is temporarily stored in the sending buffer unit SBF. After the exposure device 15 subjects the substrate W to the exposure processing, the interface transporting mechanism IFR takes out the substrate W from a substrate carry-out section 15b (see FIG. 1) in the exposure device 15, and carries the substrate W into the post-exposure cleaning/drying group 95. The carry-in/carry-out section 15a/15b is also referred to as a transfer section.

As described in the foregoing, in the post-exposure cleaning/drying unit DRY in the post-exposure cleaning/drying processing group 95, a processing liquid (a cleaning liquid and a rinse liquid) is supplied from the nozzle 92 to a top surface of the substrate W that rotates in a horizontal attitude by the spin chuck 91 (see FIG. 2). This causes the top surface of the substrate W to be cleaned. Thereafter, the supply of the processing liquid from the nozzle 92 to the substrate W is stopped, which causes the cleaning liquid that adheres to the substrate W to be scattered while causing the top surface of the substrate W to be dried (scattering drying).

Note that the post-exposure cleaning/drying unit DRY may be provided with a gas spray nozzle that sprays inert gas on the top surface of the substrate W. In this case, the inert gas is sprayed on the substrate W from the gas spray nozzle while the substrate W is being subjected to the scattering drying or after a liquid layer of the rinse liquid is formed on the top surface of the substrate W, which causes the top surface of the substrate W to be reliably dried.

In the post-exposure cleaning/drying processing group 95, the substrate W after the exposure processing is thus subjected to the cleaning and drying processing. After the substrate W after the exposure processing is subjected to the cleaning and drying processing, the interface transporting mechanism IFR takes out the substrate W from the post-exposure cleaning/drying processing group 95, and places the substrate W on the substrate platform PASS12. When the cleaning and drying processing cannot be temporarily performed in the post-exposure cleaning/drying processing group 95 due to a failure or the like, the substrate W after the exposure processing can be temporarily stored in the return buffer unit RBF in the interface block 16. The substrate W placed on the substrate platform PASS12 is received by the sixth central robot CR6 in the interface block 14. The sixth central robot CR6 carries the substrate W into the thermal processing group 151 in the cleaning/drying processing block 13.

In the thermal processing group 151, the substrate W is subjected to post-exposure bake (PEB). Thereafter, the sixth central robot CR6 takes out the substrate W from the thermal processing group 151, and places the substrate W on the substrate platform PASS10. Although the thermal processing group 151 subjects the substrate W to post-exposure bake in the present embodiment, the thermal processing group 150b may subject the substrate W to post-exposure bake.

The substrate W placed on the substrate platform PASS10 is received by the fifth central robot CR5 in the cleaning/drying processing block 13. The fifth central robot CR5 places the substrate W on the substrate platform PASS8. The substrate W placed on the substrate platform PASS8 is received by the fourth central robot CR4 in the development/cleaning/drying processing block 12. The fourth central robot CR4 carries the substrate W into the development processing group 620. In the development processing group 620, the development processing unit DEV subjects the substrate W to the development processing. Thereafter, the fourth central robot CR4 takes out the substrate W that has been subjected to the development processing from the development processing group 620, and places the substrate W on the substrate platform PASS6.

The substrate W placed on the substrate platform PASS6 is received by the third central robot CR3 in the resist film processing block 11. The third central robot CR3 carries the substrate W into the thermal processing group 111. The third central robot CR3 then takes out the thermally processed substrate W from the thermal processing group 111, and places the substrate W on the substrate platform PASS4. The substrate W placed on the substrate platform PASS4 is received by the second central robot CR2 in the anti-reflection film processing block 10. The second central robot CR2 places the substrate W on the substrate platform PASS2. The substrate W placed on the substrate platform PASS2 is stored in the carrier C by the indexer robot IR in the indexer block 9.

As to the Top Surface and Edge Cleaning/Drying Unit

The top surface and edge cleaning/drying unit SD (FIG. 3) provided in the first cleaning/drying processing group 610 in the development/cleaning/drying processing block 12 will be herein described in detail with reference to the drawings. Note that the operation of each of constituent elements in the top surface and edge cleaning/drying unit SD, described below, is controlled by the main controller (controller) 91 shown in FIG. 1.

Configuration of the Top Surface and Edge Cleaning/Drying Unit

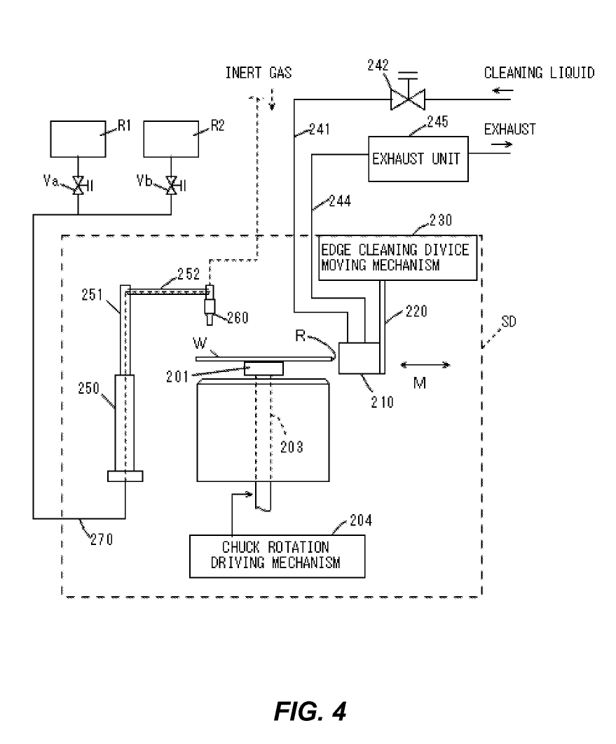

FIG. 4 is a diagram for explaining the configuration of the top surface and edge cleaning/drying unit SD. In the top surface and edge cleaning/drying unit SD, the top surface and the edge of the substrate W are cleaned (top surface and edge cleaning processing). As shown in FIG. 4, the top surface and edge cleaning/drying unit SD includes a spin chuck 201 for rotating the substrate W about a vertical rotation axis passing through the center of the substrate W while horizontally holding the substrate W.

The spin chuck 201 is secured to an upper end of a rotation shaft 203 that is rotated by a chuck rotation driving mechanism 204. A suction path (not shown) is formed in the spin chuck 201. Air inside the suction path is exhausted with the substrate W placed on the spin chuck 201, to adsorb the lower surface of the substrate W on the spin chuck 201 under vacuum, so that the substrate W can be held in a horizontal attitude. A motor 250 is provided beside the spin chuck 201. A rotation shaft 251 is connected to the motor 250. An arm 252 is connected to the rotation shaft 251 so as to extend in the horizontal direction, and its tip is provided with a top surface cleaning nozzle 260.

The motor 250 causes the rotation shaft 251 to rotate while causing the arm 252 to swing. This allows the top surface cleaning nozzle 260 to move between an upper position and an outer position of the substrate W held by the spin chuck 201. A supply pipe 270 for cleaning processing is provided so as to pass through the motor 250, the rotation shaft 251, and the arm 252. The supply pipe 270 is connected to a cleaning liquid supply source R1 and a rinse liquid supply source R2 through a valve Va and a valve Vb, respectively.

By controlling the opening and closing of the valves Va and Vb, it is possible to select a processing liquid supplied to the supply pipe 270 and adjust the supply amount thereof. In the configuration shown in FIG. 4, a cleaning liquid can be supplied to the supply pipe 270 by opening the valve Va, and a rinse liquid can be supplied to the supply pipe 270 by opening the valve Vb. By thus controlling the opening and closing of the valves Va and Vb, it is possible to supply the cleaning liquid or the rinse liquid to the top surface of the substrate W through the supply pipe 270 and the top surface cleaning nozzle 260. This allows the top surface of the substrate W to be cleaned.

An example of the cleaning liquid is any one of a predetermined resist solvent, a fluorine-based medical liquid, an ammonia/hydrogen peroxide mixture, and a liquid used for the liquid immersion method in the exposure device 17. Another example of the cleaning liquid can be also any one of pure water, a pure water solution containing a complex (ionized), carbonic water, hydrogen water, electrolytic ionic water, HFE (hydrofluoroether), hydrofluoric acid, sulfuric acid, and a sulfuric acid/hydrogen peroxide mixture. An example of the rinse liquid is any one of pure water, carbonated water, hydrogen water, electrolytic ionic water, and HFE.

Furthermore, an edge cleaning device moving mechanism 230 is provided beside the spin chuck 201 and in an upper part of the top surface and edge cleaning/drying unit SD. A stick-shaped supporting member 220 extending downward is attached to the edge cleaning device moving mechanism 230. The supporting member 220 moves in the vertical direction and the horizontal direction by the edge cleaning device moving mechanism 230.

An edge cleaning device 210 having a substantially cylindrical shape is attached to a lower end of the supporting member 220 so as to extend in the horizontal direction. This causes the edge cleaning device 210, together with the supporting member 220, to move by the edge cleaning device moving mechanism 230. This allows one end of the edge cleaning device 210 to be opposite to the edge R of the substrate W held in the spin chuck 201. In the following description, the one end, which is opposite to the edge R of the substrate W, of the edge cleaning device 210 is taken as a front surface.

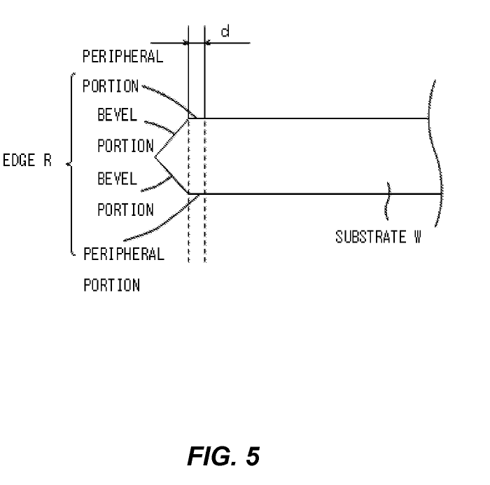

The definition of the edge R of the substrate W will be herein described while referring to the following drawings. FIG. 5 is a schematic view for explaining the edge R of the substrate W. An anti-reflection film and a resist film (both are not illustrated), described above, are formed on the substrate W.

The substrate W has an end surface. The end surface is as schematically illustrated in FIG. 5. The end surface is generally referred to as a bevel portion. A region inwardly spaced a distance d apart from an end of the top surface of the substrate W on which the resist film is formed is generally referred to as a peripheral portion. In the present embodiment, the bevel portion and the peripheral portion are generically referred to as an edge R. Note that the distance d is 2 to 3 mm, for example. Furthermore, the edge R need not include the peripheral portion. In this case, the top surface and edge cleaning/drying unit SD cleans only the bevel portion at the edge R of the substrate W. Generally, one or both of the anti-reflection film and the resist film formed in the peripheral portion on the substrate W is/are exposed.

Returning to FIG. 4, the edge cleaning device 210 moves to a position in the vicinity of the edge R of the substrate W on the spin chuck 201 by the edge cleaning device moving mechanism 230 during the top surface and edge cleaning processing, while waiting outside the spin chuck 201 in a time period during which the top surface and edge cleaning processing is not performed.

The edge cleaning device 210 has a space in its inner part (a cleaning chamber 211, described later). A cleaning liquid supply pipe 241 and an exhaust pipe 244 are connected to the edge cleaning device 210. The cleaning liquid supply pipe 241 is connected to a cleaning liquid supply system (not shown) through a valve 242. By opening the valve 242, the cleaning liquid is supplied to the inner space of the edge cleaning device 210 through the cleaning liquid supply pipe 241. Furthermore, the exhaust pipe 244 is connected to an exhaust unit 245. The exhaust unit 245 sucks in an atmosphere in the inner space of the edge cleaning device 210, and exhausts the air through the exhaust pipe 244.

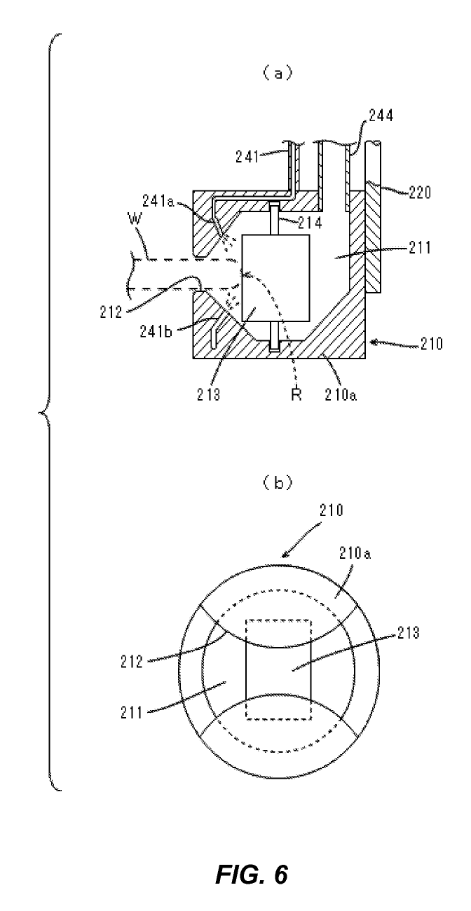

The details of the edge cleaning device 210 will be herein described. FIG. 6 is a diagram for explaining the configuration of the edge cleaning device 210 in the top surface and edge cleaning/drying unit SD shown in FIG. 4. FIG. 6 (a) is a vertical sectional view of the edge cleaning device 210, and FIG. 6 (b) is a front view of the edge cleaning device 210.

As shown in FIG. 6 (a), a cleaning chamber 211 is formed inside a substantially cylindrical housing 210a in the edge cleaning device 210. Furthermore, as shown in FIGS. 6 (a) and 6 (b), an opening 212 for causing the cleaning chamber 211 and the outside of the housing 210a to communicate with each other is formed on a front surface of the housing 210a. The opening 212 has an upper surface and a lower surface in a circular arc shape such that the vertical width thereof is gradually enlarged sideward on both sides from the center thereof. During the top surface and edge cleaning processing of the substrate W, the edge R of the substrate W held by suction on the spin chuck 201 is inserted into the opening 212.

A brush 213 having a substantially cylindrical shape is arranged so as to extend in the vertical direction within the cleaning chamber 211. The brush 213 is attached to a rotation shaft 214 extending in the vertical direction. An upper end and a lower end of the rotation shaft 214 are respectively attached to rotation bearings respectively formed at the top and the bottom of the cleaning chamber 211. This causes the brush 213 to be rotatably supported by the cleaning chamber 211 and the rotation shaft 214. During the top surface and edge cleaning processing of the substrate W, the edge R of the rotating substrate W and the brush 213 come into contact with each other. This causes the edge R of the substrate W to be cleaned with the brush 213.

Here, in the top surface and edge cleaning/drying unit SD shown in FIG. 4, the rotation shaft 214 having the brush 213 attached thereto is arranged so as to be substantially parallel to the rotation shaft 203 having the spin chuck 201 secured thereto. This causes the brush 213 to rotate with the brush 213 brought into reliable contact with the edge R of the rotating substrate W. The cleaning liquid supply pipe 241 and the exhaust pipe 244, described above, are connected to the top of the edge cleaning device 210.

The cleaning liquid supply pipe 241 is connected to cleaning liquid supply paths 241a and 241b formed within the housing 210a. As shown in FIG. 6 (a), the cleaning liquid supply path 241a extends to an inner surface in an upper part of the cleaning chamber 211 from the outside of the housing 210a. The cleaning liquid supply path 241b extends to an inner surface in a lower part of the cleaning chamber 211 from the outside of the housing 210a. FIG. 6 (a) illustrates only a part of the cleaning liquid supply pipe 241b.

Such a configuration causes the cleaning liquid supplied to the edge cleaning device 210 to be sprayed in the vertical direction toward the edge R of the substrate W that comes into contact with the brush 213 within the cleaning chamber 211 during the top surface and edge cleaning processing of the substrate W. This causes the edge R of the substrate W to be efficiently cleaned.

The exhaust pipe 244 is inserted into the cleaning chamber 211 through a hole provided at the top of the housing 210a. This causes an atmosphere in the cleaning chamber 211 to be sucked in by the exhaust unit 245 shown in FIG. 4 and exhausted through the exhaust pipe 244, as described above. In the cleaning chamber 211, the exhaust unit 245 thus exhausts the atmosphere inside thereof, so that the volatilized cleaning liquid and a mist of the cleaning liquid are efficiently exhausted.

In the foregoing, an example of the cleaning liquid sprayed on the edge R of the substrate W is any one of a predetermined resist solvent, a fluorine-based medical liquid, an ammonia/hydrogen peroxide mixture, and a liquid used for the liquid immersion method in the exposure device 17. Another example of the cleaning liquid can be also any one of pure water, a pure water solution containing a complex (ionized), carbonic water, hydrogen water, electrolytic ionic water, HFE (hydrofluoroether), hydrofluoric acid, sulfuric acid, and a sulfuric acid/hydrogen peroxide mixture, similarly to the example of the cleaning liquid for cleaning the top surface of the substrate W.

When the edge R of the substrate W is cleaned with the brush 213, as described above, the brush 213 is brought into direct contact with the edge R of the substrate W, so that a contaminant at the edge R of the substrate W can be physically stripped. This allows the contaminant that has firmly adhered to the edge R to be more reliably removed.

Operations of the Top Surface and Edge Cleaning/Drying Unit

The processing operation of the top surface and edge cleaning/drying processing unit SD having the above-mentioned configuration will be described. Note that the operation of each of constituent elements in the top surface and edge cleaning/drying unit SD, described below, is controlled by the main controller (controller) 91 shown in FIG. 1. When the substrate W is carried into the top surface and edge cleaning/drying unit SD, the fourth central robot CR4 shown in FIG. 1 places the substrate W on the spin chuck 201. The substrate W placed on the spin chuck 201 is held by suction on the spin chuck 201. Then, the top surface cleaning nozzle 260 moves to above the center of the substrate W while the edge cleaning device 210 moves to a position in the vicinity of the edge R of the substrate W on the spin chuck 201. The rotation shaft 203 rotates so that the substrate W rotates.

In this state, the cleaning liquid is discharged to the top surface of the substrate W from the top surface cleaning nozzle 260. This causes the top surface of the substrate W to be cleaned. At the same time, the cleaning liquid is supplied to the edge cleaning device 210. This causes the edge R of the substrate W to be cleaned.

After an elapse of a predetermined time period, the top surface cleaning nozzle 260 discharges the rinse liquid to the top surface of the substrate W in place of the cleaning liquid. This causes the cleaning liquid supplied onto the substrate W to be cleaned away. At this time, the supply of the cleaning liquid to the edge cleaning device 210 is stopped. Thus, the rinse liquid discharged to the top surface of the substrate W flows into the edge R of the substrate W, so that the cleaning liquid that adheres to the edge R of the substrate W is cleaned away. Furthermore, after an elapse of a predetermined time period, the top surface cleaning nozzle 260 stops to discharge the rinse liquid to the substrate W, to move outward apart from the substrate W held by the spin chuck 201. The edge cleaning device 210 also moves outward apart from the substrate W.

The number of revolutions of the rotation shaft 203 increases. This causes a great centrifugal force to act on the rinse liquid remaining on the substrate W. Thus, the liquid that adheres to the top surface and the edge R of the substrate W is scattered, so that the substrate W is dried. The cleaning liquid and the rinse liquid may be supplied onto the substrate W by means of a soft spray method using a two-fluid nozzle that discharges a fluid mixture of a gas and a liquid.

When the two-fluid nozzle is used as the top surface cleaning nozzle 260 shown in FIG. 4, the two-fluid nozzle that sprays the fluid mixture is moved so as to pass through the center of the rotating substrate W from the outside of the substrate W. This allows the fluid mixture including the cleaning liquid or the rinse liquid to be efficiently sprayed over the whole surface of the substrate W. When the two-fluid nozzle is thus used, inert gas such as nitrogen gas (N₂), argon gas, or helium gas must be supplied to the top surface cleaning nozzle 260, as indicated by a dotted line in FIG. 4.

Another Example of a Configuration of the Top Surface and Edge Cleaning/Drying Unit

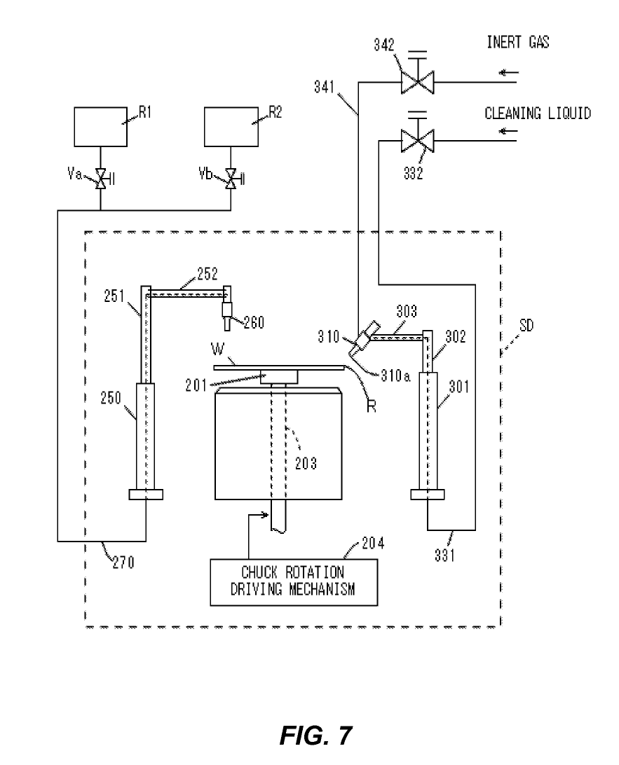

The top surface and edge cleaning/drying unit SD may have the following configuration. FIG. 7 is a diagram for explaining another example of the configuration of the top surface and edge cleaning/drying unit SD. The difference between the top surface and edge cleaning/drying unit SD shown in FIG. 7 and the top surface and edge cleaning/drying unit SD shown in FIG. 4 will be described. As shown in FIG. 7, in the top surface and edge cleaning/drying unit SD in this example, a two-fluid nozzle 310 is provided as a constituent element for cleaning an edge R of a substrate W in place of the edge cleaning device 210 shown in FIG. 4.

Specifically, a motor 301 is provided outside a spin chuck 201. A rotation shaft 302 is connected to the motor 301. An arm 303 is connected to the rotation shaft 302 so as to extend in the horizontal direction, and the two-fluid nozzle 310 is provided at the tip of the arm 303. The two-fluid nozzle 310 discharges a fluid mixture of a gas and a liquid. Note that at the tip of the arm 303, the two-fluid nozzle 310 is attached thereto so as to be inclined to a top surface of the substrate W held by the spin chuck 201.

When top surface and edge cleaning processing of the substrate W is started, the motor 301 causes the rotation shaft 302 to rotate while causing the arm 303 to swing. This causes the two-fluid nozzle 310 to move to above the edge R of the substrate W held by the spin chuck 201 As a result, a discharge section 310a of the fluid mixture in the two-fluid nozzle 310 is opposite to the edge R of the substrate W.

A cleaning liquid supply pipe 331 is provided so as to pass through the motor 301, the rotation shaft 302, and the arm 303. The cleaning liquid supply pipe 331 has its one end connected to the two-fluid nozzle 310 and the other end connected to a cleaning liquid supply system (not shown) through a valve 332. A cleaning liquid is supplied to the two-fluid nozzle 310 through the cleaning liquid supply pipe 331 by opening the valve 332.

One end of a gas supply pipe 341, together with the cleaning liquid supply pipe 331, is connected to the two-fluid nozzle 310. The other end of the gas supply pipe 341 is connected to a gas supply system (not shown) through a valve 342. A gas is supplied to the two-fluid nozzle 310 by opening the valve 342. An example of the gas supplied to the two-fluid nozzle 310 is inert gas such as nitrogen gas (N₂), argon gas, or helium gas.

When the substrate W is subjected to the top surface and edge cleaning processing, the cleaning liquid and the gas are supplied to the two-fluid nozzle 310. This causes the cleaning liquid and a rinse liquid to be discharged from the top surface cleaning nozzle 260 to the top surface of the substrate W while causing the fluid mixture to be discharged from the two-fluid nozzle 310 to the edge R of the rotating substrate W.

Thus, a high cleaning effect can be obtained by using the fluid mixture. This causes the edge R of the substrate W to be satisfactorily cleaned. The fluid mixture of the gas and the liquid is discharged to the edge R of the substrate W, so that the edge R of the substrate W is cleaned in non-contact, which prevents the edge R of the substrate W from being damaged during the cleaning. Furthermore, it is also possible to easily control the cleaning conditions of the edge R of the substrate W by controlling the discharge pressure of the fluid mixture and the ratio of the gas and the liquid in the fluid mixture. Furthermore, the two-fluid nozzle 310 allows the uniform fluid mixture to be discharged to the edge R of the substrate W, which prevents the edge R from being non-uniform in cleaning.

The present invention is not limited to the above-mentioned example. For example, in the top surface and edge cleaning/drying unit SD, a ultrasonic nozzle containing a high-frequency vibrator may be used as a constituent element for cleaning the edge R of the substrate W.

As to the Back Surface Cleaning Unit

The back surface cleaning unit SDR (FIG. 2) provided in the second cleaning/drying processing group 630 in the cleaning/drying processing group 13 will be herein described in detail with reference to the drawings. Note that the operation of each of constituent elements in the back surface cleaning unit SDR, described below, is controlled by the main controller (controller) 91 shown in FIG. 1.

Configuration of the Back Surface Cleaning Unit

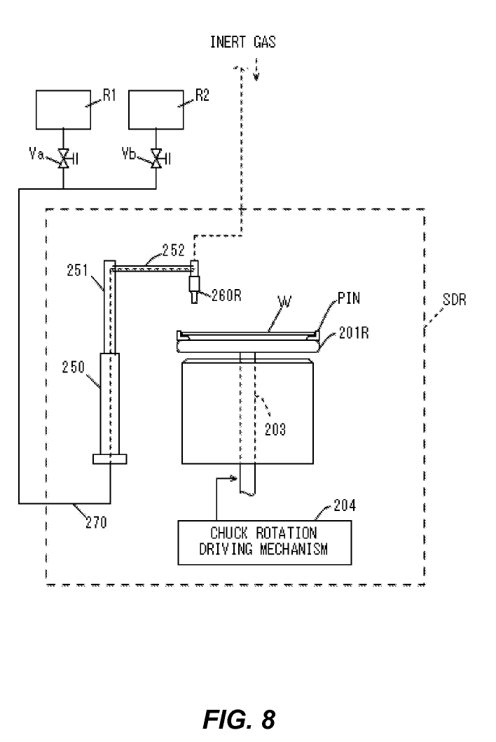

FIG. 8 is a diagram for explaining the configuration of the back surface cleaning unit SD. The back surface cleaning unit SDR cleans the back surface of the substrate W (back surface cleaning processing). As shown in FIG. 8, the back surface cleaning unit SDR includes a mechanical spin chuck 201R for rotating the substrate W about a vertical axis passing through the center of the substrate W while horizontally holding the substrate W. The spin chuck 201R holds an outer peripheral portion of the substrate W. The spin chuck 201R is secured to an upper end of a rotation shaft 203 that is rotated by a chuck rotation driving mechanism 204.

As described in the foregoing, the substrate W is carried into the back surface cleaning unit SDR with the back surface thereof directed upward. Therefore, the substrate W is held by the spin chuck 201R with the back surface thereof directed upward. At the time of the back surface cleaning processing, the substrate W is rotated while maintaining a horizontal attitude with a peripheral portion on its lower surface and the outer peripheral portion held by a spin holding pin PIN on the spin chuck 201R.

A motor 250 is provided outside the spin chuck 201R, as in the top surface and edge cleaning/drying unit SD. A rotation shaft 250 is connected to the motor 250. An arm 252 is connected to the rotation shaft 251 so as to extend in the horizontal direction, and its tip is provided with a back surface cleaning nozzle 260R. The motor 250 causes the rotation shaft 251 to rotate while causing the arm 252 to swing. This allows the back surface cleaning nozzle 260R to move between an upper position and an outer position of the substrate W held by the spin chuck 201R.

A supply pipe 270 for cleaning processing is provided so as to pass through the motor 250, the rotation shaft 251, and the arm 252. The supply pipe 270 is connected to a cleaning liquid supply source R1 and a rinse liquid supply source R2 through a valve Va and a valve Vb, respectively, as in the top surface and edge cleaning/drying unit SD. By controlling the opening and closing of the valves Va and Vb, it is possible to supply a cleaning liquid or a rinse liquid to the back surface of the substrate W through the supply pipe 270 and the back surface cleaning nozzle 260R. This allows the back surface of the substrate W to be cleaned.

Operations of the Back Surface Cleaning Unit

When the substrate W is carried into the back surface cleaning unit SDR, the fifth central robot CR5 shown in FIG. 1 places the substrate W on the spin chuck 201R. The substrate W placed on the spin chuck 201 is held by the spin chuck 201R. The back surface cleaning nozzle 260R then moves to above the center of the substrate W. The rotation shaft 203 rotates so that the substrate W rotates. In this state, the cleaning liquid is discharged to the back surface of the substrate W from the back surface cleaning nozzle 260R. This causes the back surface of the substrate W to be cleaned.

After an elapse of a predetermined time period, the back surface cleaning nozzle 260R discharges the rinse liquid to the back surface of the substrate W in place of the cleaning liquid. This causes the cleaning liquid supplied onto the substrate W to be cleaned away. Furthermore, after an elapse of a predetermined time period, the back surface cleaning nozzle 260R moves outward apart from the substrate W held by the spin chuck 201R after stopping to discharge the rinse liquid to the substrate W. The number of revolutions of the rotation shaft 203 increases. This causes a great centrifugal force to act on the rinse liquid remaining on the substrate W. Thus, a liquid that adheres to the back surface and an edge of the substrate W is scattered, so that the substrate W is dried.

In the back surface cleaning unit SDR, the cleaning liquid and the rinse liquid may be also supplied onto the substrate W by means of a soft spray method using a two-fluid nozzle that discharges a fluid mixture of a gas and a liquid. When the two-fluid nozzle is used, inert gas such as nitrogen gas (N₂), argon gas, or helium gas must be supplied, as indicated by a dotted line in FIG. 8, to the back surface cleaning nozzle 260R.

As to the Reversing Unit

The reversing unit RT (FIG. 3) provided in the substrate reversing group 150a in the cleaning/drying processing block 13 will be herein described in detail with reference to the drawings. Note that the operation of each of constituent elements in the reversing unit RT, described below, is controlled by the main controller (controller) 91 shown in FIG. 1.

Configuration of the Reversing Unit

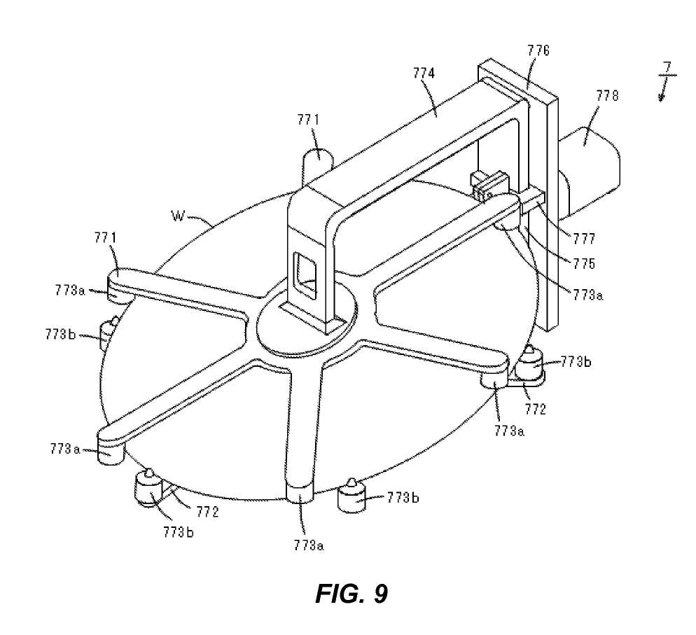

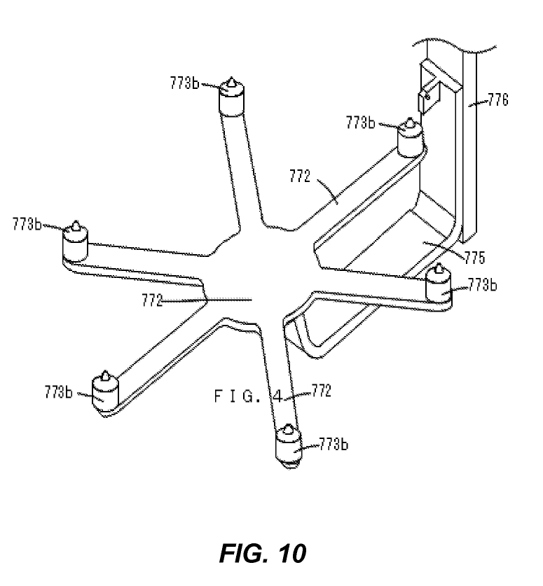

FIG. 9 is a perspective view showing the appearance of a substrate reversing device 7 provided in the reversing unit RT, and FIG. 10 is a perspective view showing the appearance of a part of the substrate reversing device 7. As shown in FIGS. 9 and 10, the substrate reversing device 7 includes a first supporting member 771, a second supporting member 772, a plurality of substrate support pins 773a and 773b, a first movable member 774, a second movable member 775, a fixed plate 776, a rink mechanism 777, and a rotating mechanism 778.

As shown in FIG. 10, the second supporting member 772 is composed of six stick-shaped members radially extending. Each of the six stick-shaped members has the substrate support pin 773b provided at its tip. Similarly, as shown in FIG. 9, the first supporting member 771 is also composed of six stick-shaped members radially extending. Each of the six stick-shaped members has the substrate support pin 773a provided at its tip.

Although in the illustrated embodiment, each of the first and second supporting members 771 and 772 is composed of six stick-shaped members, the present invention is not limited to the same. Each of the first and second supporting members may be composed of stick-shaped members in any other number or members in any other shape. For example, the first and second supporting members 771 and 772 may be respectively formed in other shapes such as disk shapes or polygonal shapes having outer peripheries along the plurality of first and second substrate support pins 773a and 773b.

The first movable member 774 has a U shape. The first supporting member 771 is fixed to one end of the first movable member 774. The other end of the first movable member 774 is connected to the link mechanism 777. Similarly, the second movable member 775 has a U shape. The second supporting member 772 is fixed to one end of the second movable member 775. The other end of the second movable member 775 is connected to the link mechanism 777. The link mechanism 777 is attached to a rotation axis of the rotating mechanism 778. The link mechanism 777 and the rotating mechanism 778 are attached to the fixed plate 776.

The link mechanism 777 shown in FIG. 9 contains an air cylinder or the like, which allows the first movable member 774 and the second movable member 775 to move to a relatively spaced state and a closely-spaced state. Furthermore, the rotating mechanism 778 shown in FIG. 9 contains a motor or the like, which allows the first movable member 774 and the second movable member 775 to rotate through an angle of 180 degrees, for example, about a horizontal axis through the link mechanism 777.

Operations of the Reversing Unit

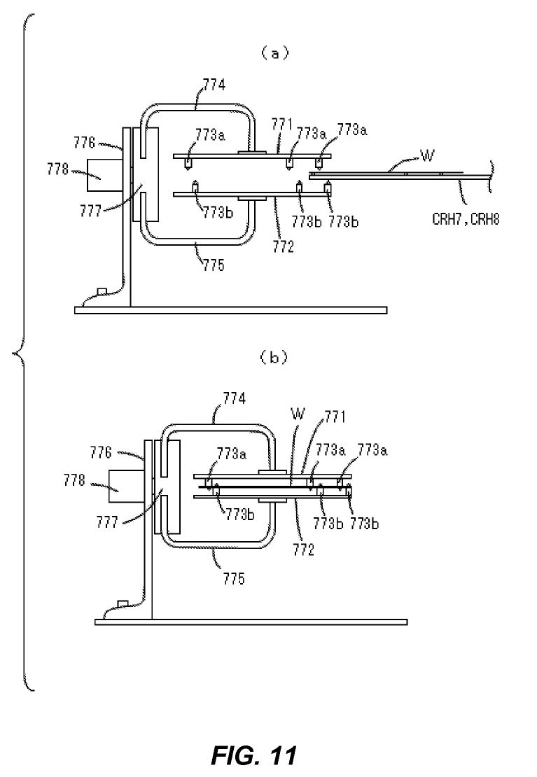

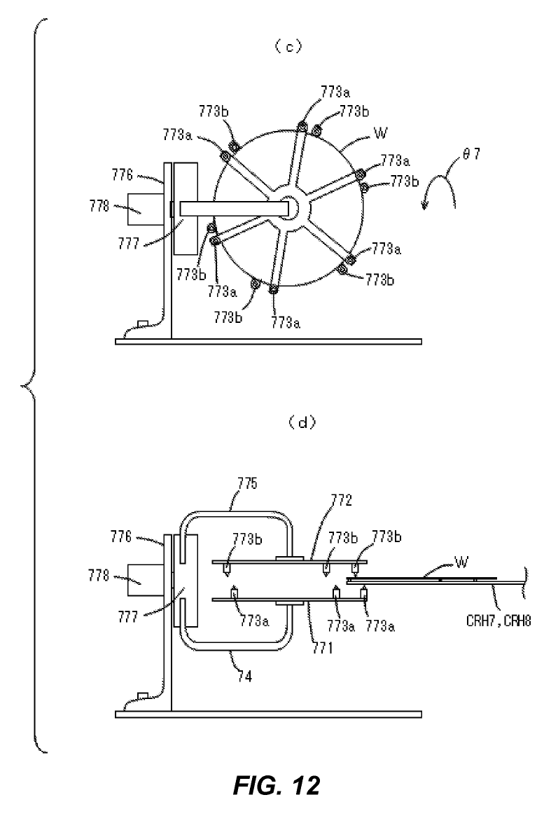

FIGS. 11 and 12 are schematic views showing the operations of the substrate reversing device 7 shown in FIG. 9.

Substrate Placing Step

As shown in FIG. 11 (a), the fifth central robot CR5 shown in FIG. 1 carries the substrate W into the substrate reversing device 7. In this case, the action of the link mechanism 777 causes the first movable member 774 and the second movable member 775 to be held in a vertically spaced state. The hands CRH7 and CRH8 of the fifth central robot CR5 transfer the substrate W onto the plurality of substrate support pins 773b in the second supporting member 772. After the substrate W is transferred, the hands CRH7 and CRH8 of the fifth central robot CR5 exit from the substrate reversing device 7.

Then, as shown in FIG. 11 (b), the action of the link mechanism 777 causes the first movable member 774 and the second movable member 775 to move to a vertically closely-spaced state. Subsequently, as shown in FIG. 12 (c), the action of the rotating mechanism 778 causes the first movable member 774 and the second movable member 775 to rotate through an angle of 180 degrees in a direction indicated by an arrow 07 about a horizontal axis.

In this case, the substrate W, together with the first movable member 774 and the second movable member 775, rotates through an angle of 180 degrees while being held by the plurality of substrate support pins 773a and 773b respectively provided in the first supporting member 771 and the second supporting member 772. Finally, the action of the link mechanism 777 causes the first movable member 774 and the second movable member 775 to move to a vertically spaced state. The hands CRH7 and CRH8 of the fifth central robot CR5 enter the substrate reversing device 7, and exit therefrom with the substrate W transferred thereon, as shown in FIG. 12 (d).

Effects of Back Surface Cleaning Processing

In the substrate processing apparatus 500 according to the present embodiment, the back surface cleaning unit SDR in the second cleaning/drying processing group 630 in the cleaning/drying processing block 13 subjects the substrate W before the exposure processing to the back surface cleaning processing.

This causes the back surface of the substrate W before the exposure processing by the exposure device 15 to be kept clean. As a result, contamination in the exposure device 15 due to contamination on the back surface of the substrate W before the exposure processing can be sufficiently prevented, which can sufficiently prevent a defective dimension and a defective shape of an exposure pattern.

First Effect of the Top Surface and Edge Cleaning Processing

In the substrate processing apparatus 500, the top surface and edge cleaning/drying unit SD provided in the first cleaning/drying processing group 610 in the development/cleaning/drying processing block 12 subjects the substrate W before the exposure processing to the top surface and edge cleaning processing.

This causes the top surface and the edge of the substrate W before the exposure processing by the exposure device 15, in addition to the back surface of the substrate W, to be kept clean. As a result, contamination in the exposure device 15 is sufficiently prevented, which more sufficiently prevents a defective dimension and a defective shape of an exposure pattern.

Second Effect of the Top Surface and Edge Cleaning Processing

Furthermore, in the substrate processing apparatus 500, the top surface and the edge of the substrate W can be simultaneously cleaned within the top surface and edge cleaning/drying unit SD. When the top surface and the edge of the substrate W before the exposure processing are cleaned, therefore, the top surface and the edge of the substrate W need not be individually cleaned, which prevents throughput in substrate processing from being reduced. Furthermore, the top surface cleaning unit that cleans the top surface of the substrate W and the edge cleaning unit that cleans the edge of the substrate W need not be individually provided.

This causes the development/cleaning/drying processing block 12 to be miniaturized. Throughput in substrate processing can be further improved by increasing the number of top surface and edge cleaning/drying units SD provided within the development/cleaning/drying processing block 12. Furthermore, another processing unit can be also provided within the first cleaning/drying processing group 610 in the development/cleaning/drying processing block 12.

First Effect of the Layout

In the development/cleaning/drying processing block 12, the substrate W the top surface and the edge of which have been cleaned is transported to the cleaning/drying processing block 13 adjacent to the development/cleaning/drying processing block 12. In the cleaning/drying processing block 13, the reversing unit RT reverses the substrate W, so that the back surface cleaning unit SDR cleans the back surface of the substrate W.

After the top surface and the edge of the substrate W are thus cleaned, the back surface of the substrate W is continuously cleaned. Therefore, the whole surface of the substrate W is efficiently cleaned, which allows the cleanliness of the substrate W to be improved. Particularly although the back surface of the substrate W is held by suction on the spin chuck 201 (FIG. 4) at the time of the top surface and edge cleaning processing, the back surface cleaning processing is quickly performed after the top surface and edge cleaning processing. Therefore, suction marks on the back surface of the substrate W is easily removed.

Second Effect of the Layout

As described in the foregoing, in the development/cleaning/drying processing block 12, the first cleaning/drying processing group 610 and the development processing group 620 are provided opposite to each other with the fourth central robot CR4 interposed therebetween.

This allows the top surface and edge cleaning processing of the substrate W by the top surface and edge cleaning/drying unit SD and the development processing of the substrate W by the development processing unit DEV to be performed in parallel in the development/cleaning/drying processing block 12. As a result, throughput in substrate processing by the substrate processing apparatus 500 is improved.

Modification and its Effect

As to the Resist Cover Film

In the above-mentioned substrate processing apparatus 500, when the resist film formed on the top surface of the substrate W and the liquid used by the liquid immersion method in the exposure device 15 are brought into contact with each other so that a component of a resist is easily eluted in the liquid, a new processing block (a resist cover film formation block) for forming a resist cover film for protecting the resist film may be provided. In this case, the resist cover film prevents the component of the resist from being eluted in the liquid during the exposure processing by the exposure device 15.

When the resist cover film processing block is provided, a new processing block for removing the resist cover film (a resist cover film removal block) must be provided after the exposure processing by the exposure device 15 and before the development processing by the development processing group 60 in the development/cleaning/drying processing block 12.

The resist cover film is removed before the development processing, as described above. Therefore, it is preferable that the resist cover film removal block is provided among the development/cleaning/drying processing block 12, the cleaning/drying processing block 13, and the exposure device 15. This allows the substrate W after the exposure processing carried out of the exposure device 15 to be smoothly carried into the resist cover removal block and the development/cleaning/drying processing group 120 in this order. This prevents throughput from being reduced.

As to the Exposure Device

In each of the above-mentioned embodiments, the exposure device 15 may subject the substrate W to the exposure processing without using the liquid immersion method. In this case, the object of the present invention can be also achieved by providing the substrate processing apparatus 500 with a back surface cleaning unit SDR and a reversing unit RT.

Correspondences between elements in the claims and parts in embodiments

In the following paragraphs, non-limiting examples of correspondences between various elements recited in the claims below and those described above with respect to various preferred embodiments of the present invention are explained.

In the embodiments described above, the anti-reflection film processing block 10, the resist film processing block 11, the development/cleaning/drying processing block 12, and the cleaning/drying processing block 13 are examples of a processing section, the indexer block 9 is an example of a carry-in/carry-out section (also referred to as a transfer section), the interface block 14 is an example of an interface, the development/cleaning/drying processing block 12 is an example of a first processing unit, and the cleaning/drying processing block 13 is an example of a second processing unit.

The development processing group 620 is an example of a development region, the first cleaning/drying processing group 610 is an example of a first cleaning region, an installation region of the fourth central robot CR4 is an example of a first transport region, the top surface and edge cleaning/drying unit SD is an example of a top surface cleaning unit, the fourth central robot CR4 is an example of a first transport unit, the substrate reversing group 150a is an example of a reversing region, the second cleaning/drying processing group 630 is an example of a second cleaning region, an installation region of the fifth central robot CR5 is an example of a second transport region, and the fifth central robot CR is an example of the second transport unit.

Furthermore, the resist film processing block 11 is an example of a third processing unit, the resist film is an example of a photosensitive film, the coating processing group 40 for resist film is an example of a photosensitive film formation region, the thermal processing group 110 for resist film and the thermal processing group 111 for development are examples of a first thermal processing region, an installation region of the third central robot CR3 is an example of a third transport region, and the coating unit RES is an example of a photosensitive film formation unit.

The heating unit HP and the cooling unit CP in the thermal processing group for resist film and the thermal processing group 111 for development are examples of a first thermal processing unit, the third central robot CR3 is an example of a third transport unit, the heating unit HP and the cooling unit CP in the thermal processing group 111 for development are examples of a thermal processing unit for development, and the heating unit HP and the cooling unit CP in the thermal processing group 110 for resist film are examples of a thermal processing unit for photosensitive film.

Furthermore, the anti-reflection film processing block 10 is an example of a fourth processing unit, the coating processing group 30 for anti-reflection film is an example of an anti-reflection film formation region, the thermal processing groups 100 and 101 for anti-reflection film are examples of a second thermal processing region, and an installation region of the second central robot CR2 is an example of a fourth transport region.

The coating unit BAR is an example of an anti-reflection film formation unit, the heating unit HP and the cooling unit CP in the thermal processing groups 100 and 101 for anti-reflection film are examples of a second thermal processing unit, and the second central robot CR2 is an example of a fourth transport unit.

Furthermore, the post-exposure cleaning/drying processing group 95 is an example of a cleaning/drying unit, and the sixth central robot CR6 and the interface transporting mechanism IFR are examples of an interface unit.

As the elements recited in the claims, various other elements having the structure or function recited in the claims may be employed. While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A substrate processing apparatus that is arranged adjacent to an exposure device, the substrate processing apparatus comprising:
a processing section configured to subject a substrate to predetermined processing, the processing section including:
a first processing unit including a development region, a first cleaning region, and a first transport region including a first transport unit; wherein the development region and the first cleaning region are arranged opposite to each other with the first transport region interposed therebetween; and
a second processing unit including a reversing region, a second cleaning region, and a second transport region including a second transport unit, wherein the reversing region and the second cleaning region are arranged opposite to each other with the second transport region interposed therebetween;
wherein the second processing unit is arranged between the first processing unit and the exposure device;
a transfer section coupled to the processing section and configured to transfer the substrate into and out of the processing section; and
an interface configured to receive and transfer the substrate between the processing section and the exposure device.

2. The substrate processing apparatus of claim 1 wherein the development region is provided with a development unit that subjects the substrate to development processing after exposure processing by the exposure device.

3. The substrate processing apparatus of claim 1 wherein:
the first cleaning region comprises a top surface cleaning unit configured to clean a top surface of the substrate; and
the second cleaning region comprises a back surface cleaning unit configured to clean a back surface of the substrate.

4. The substrate processing apparatus of claim 1 wherein the reversing region includes a reversing unit configured to reverse one surface and an opposing surface of the substrate.

5. The substrate processing apparatus of claim 1 wherein the top surface cleaning unit and the back surface cleaning unit are configured to clean the substrate before exposure processing by the exposure device.

6. The substrate processing apparatus of claim 1 wherein the top surface cleaning unit is configured to clean the top surface and an edge of the substrate.

7. The substrate processing apparatus of claim 1 wherein the processing section further includes a third processing unit arranged between the first processing unit and the transfer section, wherein the third processing unit includes a photosensitive film formation region, a first thermal processing region, and a third transport region.

8. The substrate processing apparatus of claim 7 wherein:
the photosensitive film formation region includes a photosensitive film formation unit configured to form a photosensitive film composed of a photosensitive material on the substrate before exposure processing by the exposure device,
the first thermal processing region includes a first thermal processing unit configured to subject the substrate to thermal processing, and
the third transport region includes a third transport unit configured to transport the substrate.

9. The substrate processing apparatus of claim 8 wherein the first thermal processing unit includes a thermal processing unit for development configured to subject the substrate after development processing by the development unit to thermal processing, and a thermal processing unit for photosensitive film configured to subject the substrate after the formation of the photosensitive film by the photosensitive film formation unit to thermal processing.

10. The substrate processing apparatus of claim 1 wherein the processing section further includes a fourth processing unit arranged between the third processing unit and the transfer section.

11. The substrate processing apparatus of claim 10 wherein the fourth processing unit includes an anti-reflection film formation region, a second thermal processing region, and a fourth transport region.

12. The substrate processing apparatus of claim 11 wherein:
the anti-reflection film formation region includes an anti-reflection film formation unit configured to form an anti-reflection film on the substrate before the photosensitive film formation unit forms the photosensitive film,
the second thermal processing region includes a second thermal processing unit configured to subject the substrate to thermal processing, and
the fourth transport region includes a fourth transport unit configured to transport the substrate.

13. The substrate processing apparatus of claim 1 wherein the interface includes:
a cleaning/drying unit configured to clean and dry the substrate after exposure processing by the exposure device; and
an interface unit configured to transport the substrate.
